(19) United States
(12) Patent Application Publication
(10) Pub. No.: US 2014/0025553 A1
(43) Pub. Date: Jan. 23, 2014

(54) UNATTENDED PRECIOUS METAL DISTRIBUTION SYSTEMS, METHODS, AND APPARATUS

(71) Applicants: William David Jones, Boca Raton, FL (US); Mark B. Goldstein, Boca Raton, FL (US); Alfredo Cortellini, Fort Lauderdale, FL (US)

(72) Inventors: William David Jones, Boca Raton, FL (US); Mark B. Goldstein, Boca Raton, FL (US); Alfredo Cortellini, Fort Lauderdale, FL (US)

(73) Assignee: PMX Communities, Inc., Boca Raton, FL (US)

(21) Appl. No.: 13/978,319

(22) PCT Filed: Jan. 6, 2012
(86) PCT No.: PCT/US12/20486

§ 371 Date: Oct. 1, 2013

Related U.S. Application Data
(60) Provisional application No. 61/430,330, filed on Jan. 6, 2011.
(60) Provisional application No. 61/539,158, filed on Sep. 26, 2011.

(51) Int. Cl. G06Q 40/04

(52) U.S. Cl. CPC G06Q 40/04
USPC 705/37

(57) ABSTRACT

Apparatus, systems, and methods for unattended precious metal distribution are disclosed. A method for distributing precious metal includes maintaining user accounts on a server system and permitting access to the user accounts from unattended precious metal distribution terminals. An unattended distribution apparatus includes a precious metal distributor that dispenses precious metal in response to dispersal instructions and a remote account interface coupled to the distributor that receives withdrawal information from a remote server and issues the dispersal instructions. A distribution system includes unattended precious metal distribution terminals and a remote server system accessible by the distribution terminals.

### CROSS REFERENCE TO RELATED APPLICATIONS

This application claims the benefit of the filing dates of U.S. Provisional Patent Application Ser. No. 61/430,330 entitled “SYSTEM AND METHOD FOR ACCESSING AND TRADING PRECIOUS METAL ACCOUNTS” filed Jan. 6, 2011 and of U.S. Provisional Patent Application Ser. No. 61/539,158 entitled “SYSTEM AND METHOD FOR ACCESSING AND TRADING PRECIOUS METAL ACCOUNTS IN CONJUNCTION WITH GOLD DISPENSING TERMINAL/ATM (GDT/ATM)” filed Sep. 26, 2011, the contents of each incorporated fully herein by reference.

### BACKGROUND OF THE INVENTION

Precious metals such as silver, gold, and platinum were conventionally sold via fixed retail locations such as coin shops and bullion sales facilities (often in combination with other goods such as collectibles). More recently, precious metals have become available via the Internet, with precious metals deliveries made via traditional package carriers such as the United States Postal Service, UPS®, and FedEx®.

While purchasers may take immediate delivery of precious metals from fixed retail locations, there is little oversight and quality control. Additionally, prices are not standardized and lack consistency from transaction to transaction. Also, while fixed retail locations may allow for resale, it is subject to the shopkeeper wanting to take the precious metal back into their inventory based on their current liquidity and inventory levels. Furthermore, there is no guarantee that the price offered will be in line with market prices.

Internet sales are sometimes viewed as unreliable in that they are generally unregulated, with consumers not always paying/receiving fair market value for exchanged precious metals. Additionally, since deliveries are made via traditional package carriers, a considerable amount of delay may be introduced to each transaction. Furthermore, enforcement of contractual terms by consumers are historically inconsistent.

While some banks and financial institutions offer the service of obtaining precious metals for their customers, the resale ability is rarely offered and there is no integration of the transactions and holdings in the customer's account It is offered as a stand-alone transaction without any support such as being able to use the equity for the benefit of the customer, hedging mechanisms to limit losses, or other account management features.

### SUMMARY OF THE INVENTION

Aspects of the present invention are embodied in apparatus, systems, and methods for unattended precious metal distribution. A method for distributing precious metal includes maintaining user accounts on a server system and permitting access to the user accounts from unattended precious metal distribution terminals. An unattended distribution apparatus includes a precious metal distributor that dispenses precious metal in response to dispersal instructions and a remote account interface coupled to the distributor that receives withdrawal information from a remote server and issues the dispersal instructions. A distribution system includes unattended precious metal distribution terminals and a remote server system accessible by the distribution terminals.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. This emphasizes that according to common practice, the various features of the drawings are not drawn to scale. On the contrary, the dimensions of the various features are arbitrarily expanded or reduced for clarity. Included in the drawings are the following figures:

FIG. 1 is a perspective view of an unattended precious metal distribution system in accordance with aspects of the present invention;

FIG. 1A is a perspective view of an unattended precious metal distribution apparatus for use in the system of FIG. 1 in accordance with aspects of the present invention;

FIG. 1B is a perspective view of another unattended precious metal distribution apparatus for use in the system of FIG. 1 in accordance with aspects of the present invention;

FIG. 1C is a perspective view of another unattended precious metal distribution apparatus for use in the system of FIG. 1 in accordance with aspects of the present invention;

FIG. 2 is a flow chart of an unattended precious metal distribution method in accordance with aspects of the present invention;

FIG. 2A is a flow chart depicting a withdrawal in accordance with aspects of the present invention;

FIG. 2B is a flow chart depicting a deposit in accordance with aspects of the present invention;

FIG. 3A is a perspective view of a transaction slip dispensed by the system of FIG. 1 for a deposit of a recognized precious metal item;

FIG. 3B is a perspective view of a transaction slip dispensed by the system of FIG. 1 for a deposit of an unrecognized precious metal item;

FIG. 3C is a perspective view of a transaction slip dispensed by the system of FIG. 1 for a cash and/or check deposit;

FIG. 3D is a perspective view of a transaction slip dispensed by the system of FIG. 1 for a cash withdrawal;

FIG. 3E is a perspective view of a transaction slip dispensed by the system of FIG. 1 for a precious metal withdrawal;

FIG. 3E is a perspective view of a transaction slip dispensed by the system of FIG. 1 for a precious metal withdrawal;

FIG. 3F is a perspective view of a transaction slip dispensed by the system of FIG. 1 for issuance of debit/gift card; and

FIG. 3G is a perspective view of a transaction slip dispensed by the system of FIG. 1 for an account inquiry.

### DETAILED DESCRIPTION OF THE INVENTION

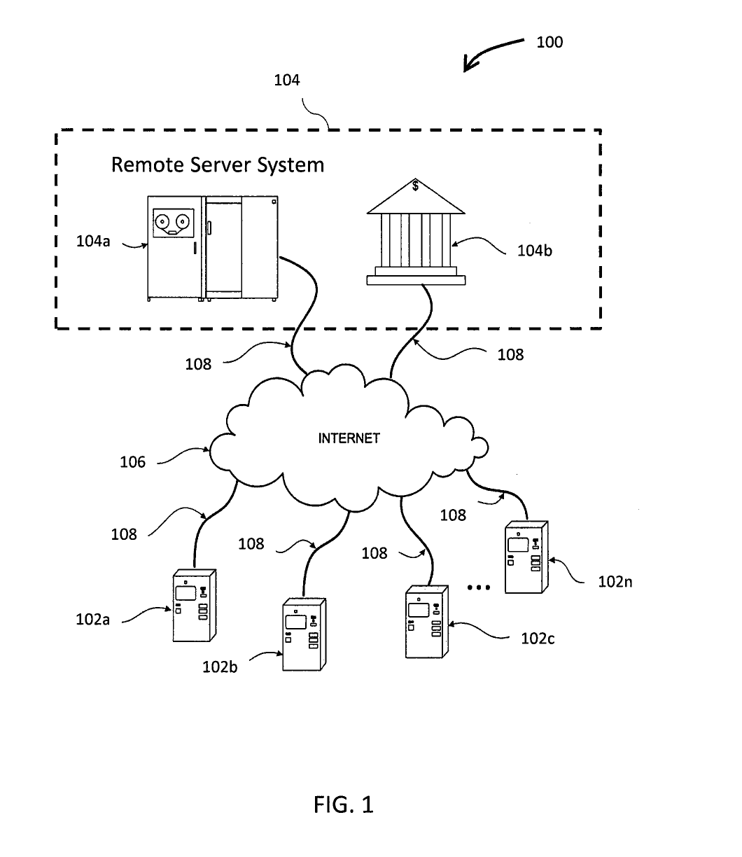

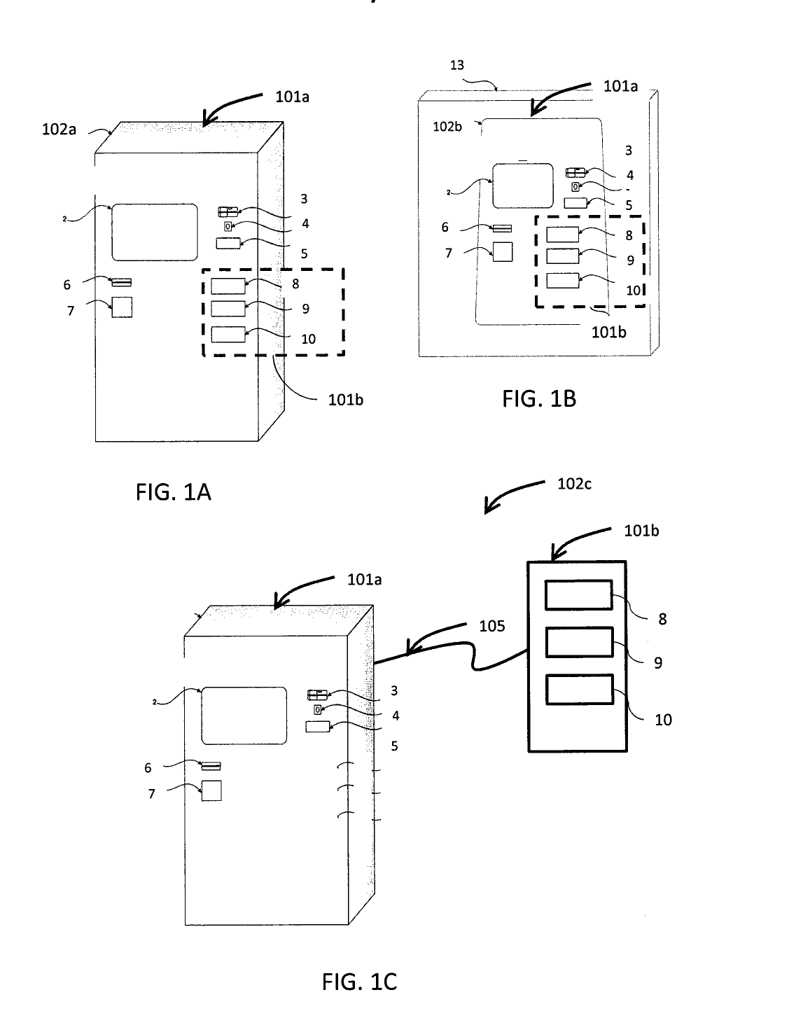

FIG. 1 depicts an unattended precious metal distribution system 100 in accordance with aspects of the present invention. System 100 includes a plurality of unattended precious metal distribution terminals 102a-n and a remote server system 104 accessible by the terminals 102. In the illustrated embodiment, terminals 102 are coupled to the server system 104 via the Internet 106 and communication paths 108. The communication paths 108 may be wired and/or wireless communication paths. Although the Internet 106 is depicted in the illustrated embodiment, other universal and/or proprietary networks may be used for communication in addition to or instead of the Internet. Embodiment of system 100 are described below primarily with reference to a single precious metal, gold. The system 100 may be used with other types of precious metals and may be used with a combination of multiple precious metals.

User accounts are maintained on the remote server system 104. The server system 104 may include one or more computer systems for maintaining the user accounts. In some embodiments, the server system 104 may be a closed system including a private computer system 104a that operates independently—maintaining user accounts and conducting user transactions via the terminals 102. In other embodiment, the server system 104 may be an open system including other entities 104b, such as banks and/or credit card companies, in addition to or instead of the private computer system to maintain user accounts and process user transactions. A few particular embodiments are described below. Other embodiments will be recognized by those of skill in the art from the description herein and are considered to be within the scope and spirit of the present invention.

The terminals 102 distribute (dispense and, optionally, accept) one or more precious metals such as silver, gold, and/or platinum. Additionally, the terminals may distribute a precious metal equivalent such as gift cards and/or codes for storage on an electronic device that may be used to redeem precious metal at another terminal. The terminals may also perform other routine banking functions such as dispensing currency (currency withdrawals), accepting currency (currency deposits), and enabling users to check their account balances, e.g., maintained by private system 104a and/or other entities 104b. System 100 may optionally include other attended or unattended terminals for accessing the remote server system 104 that do not distribute precious metals.

The terminals 102 include a remote account interface 101a and a precious metal distributor 101b coupled to the remote account interface. In one embodiment, the precious metal distributor is configured to dispense precious metal to a user in response to dispersal instructions and the remote account interface is configured to receive withdrawal fund information for an account maintained on the remote server system 104 and to issue the dispersal instructions based on the withdrawal fund information. The remote account interface 101a and the precious metal distributor 101b may be integrated into a single housing (see FIGS. 1A and 1B and the corresponding description) or may be in separate housings coupled by a wired and/or wireless tether (see FIG. 1C and the corresponding description). Each terminal 102 may include conventional automated teller machine (ATM) components and circuitry along with additional components/software for implementing the present invention. Suitable component and software for implementing the present invention will be understood by one of skill in the art from the description herein.

FIG. 1A depicts an embodiment of a free standing terminal 102a having multiple input/output ports. The illustrated terminal 102a includes a touch screen 2, magnetic card reader 3, biometric reader 4, keypad 5, currency acceptor 6, currency dispenser 7, precious metal acceptor 8, precious metal dispenser 9, and card dispenser 10. The terminal also includes a processor and a communication interface (not shown) that perform processing functions at the terminal and enable communication with the remote server system 104.

FIG. 1B depicts an embodiment of a wall mounted terminal 102b embedded in a wall 13. The illustrated wall mounted terminal 102b includes the input/output ports of free standing terminal 102a described above with reference to FIG. 1A.

FIG. 1C depicts an embodiment of a tethered terminal 102c in which a first portion 103a of the terminal 102c is separate from a second portion 103b of the terminal 102c. The two portions may be coupled by a wired and/or wireless tether 105. In accordance with this embodiment, conventional interfaces and ports such as those found in an automatic teller machine (ATM) may be present in one portion 103a and other interfaces and ports such as precious metal acceptor 8, precious metal dispenser 9, and card dispenser 10 may be present in the other portion 103b. This enables conventional ATM structures to interface with another structure to add precious metal functionality without altering the structure of the ATM. Additionally, precious metal functionality may be added to an ATM already established in a location simply by updating the software within the ATM and adding a communication interface for interfacing with a freestanding metal distributor.

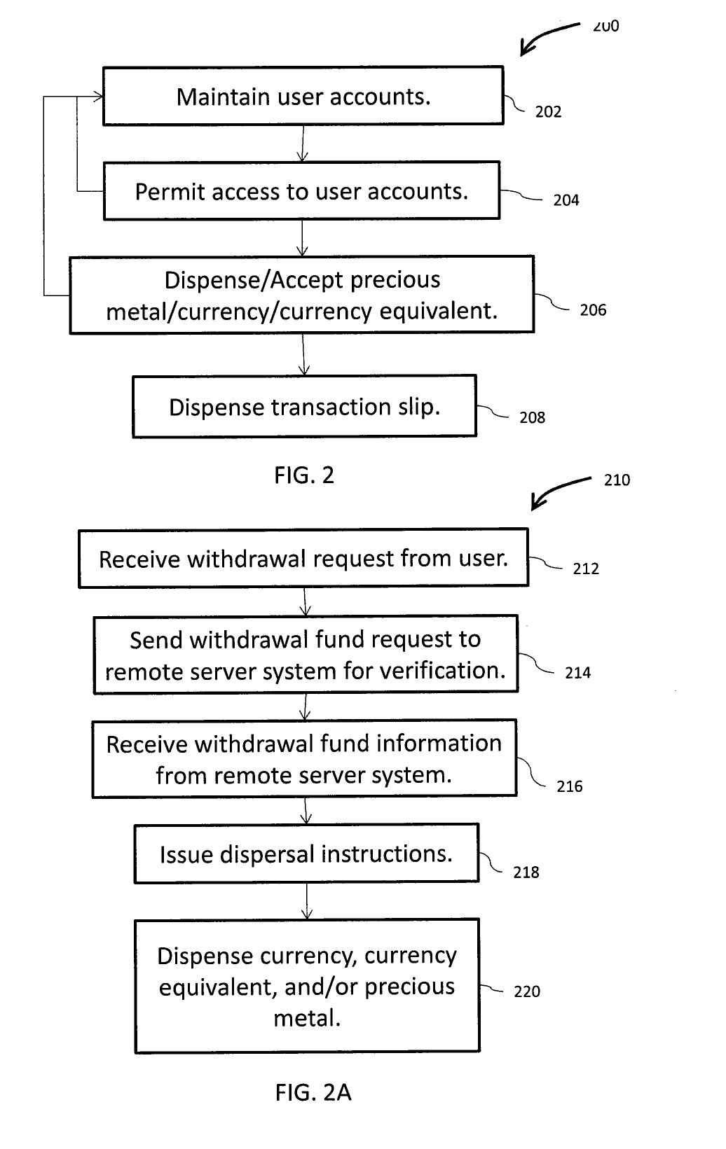

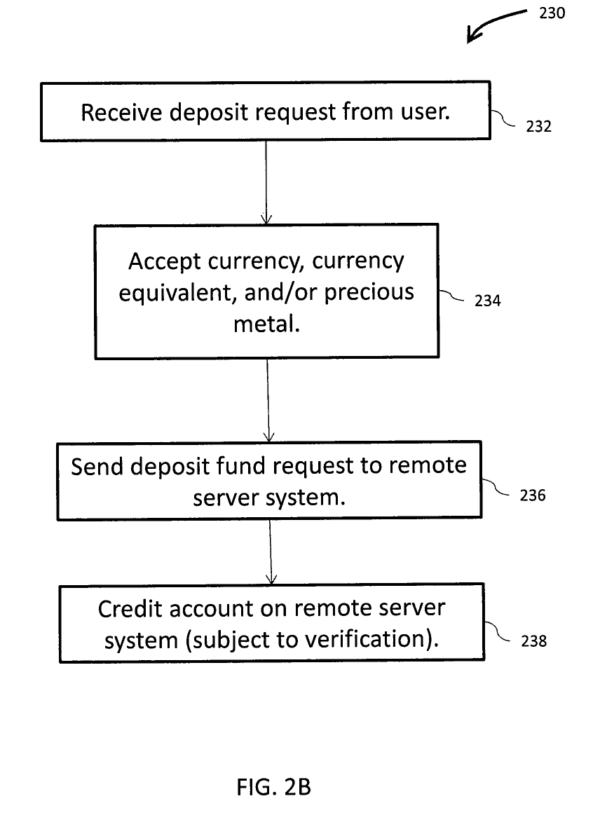

FIG. 2 depicts a flow chart 200 of exemplary steps for unattended precious metal distribution in accordance with aspects of the present invention. The steps are described below with reference to FIGS. 1 and 1a, however, implementation of the method using other devices will be understood by one of skill in the art from the description herein.

At block 202, user accounts are maintained. User accounts may be maintained by private system 104a and/or one or more other entities 104b. The user accounts may be currency based, precious metal based, or currency and precious metal based. In currency based accounts, the currency value remains constant except when value is added or removed from an account (e.g., deposit, withdrawal, interest, fees, etc.). In precious metal based accounts, the weight of the precious metal in the account remains constant except when precious metal is added/removed from the account, and the value of the account in currency fluctuates with the price of the precious metal. Each account may include multiple sub accounts, e.g., a gold sub account, a silver sub account, and a currency sub account.

At block 204, users are permitted access to their accounts. Users may access accounts maintained on remote server system 104 through terminals 102. In one embodiment, touch screen 2 enables the user to access his account after a card for the user (e.g., a convention magnetic strip card associated with the user) is read by magnetic card reader 3 and his iris is scanned by biometric reader 4 to confirm his identity. In an exemplary embodiment, once the customer and the account are verified, the user can access his account to perform a variety of transactions such as, by way of non-limiting example, withdrawing gold using funds maintained in a deposit account that is currency based or gold based, withdrawing currency using equity in a deposit account that is gold based, and/or withdrawing a gold redemption card using funds maintained in a deposit account that is currency based or gold based.

At block 206, precious metals, currency, and/or currency equivalents are dispensed/accepted. The precious metals, currency, and/or currency equivalents may be dispensed/accepted by terminals 102.

FIG. 2A depicts a flow chart 210 of exemplary steps for taking delivery of currency, a currency equivalent, and/or a precious metal, e.g., gold, from a terminal.

At block 212, a withdrawal request is received from a user. The withdrawal request may be received by a terminal 102. The withdrawal request may be for one troy ounce of gold, for example.

At block 214, a withdrawal fund request is sent to a remote server system for verification. The withdrawal fund request may be generated by a terminal 102 based on the withdrawal request from the user and sent to a remote server system 104. The remote server system 104 then verifies that adequate funds are available to honor the user's request, e.g., a suitable amount of currency, credit, gold, or other precious metal to offset the withdrawal. For an account that has a currency based value, the account value may be decreased by the currency equivalent of the requested withdraw. For an account that has a precious metal based value, the account value may be decreased by the precious metal weight equivalent of the requested withdraw.

At block 216, withdrawal fund information is received from the remote server system. The terminal 102 may receive the withdrawal fund information from the remote server system 104 after verification.

At block 218, dispersal instructions are issued. In one embodiment, a remote account interface of terminal 102 issues precious metal dispersal instructions to the precious metal distributor of terminal 102. The precious metal distributor may also be used to dispense currency and/or currency equivalents. Alternatively, currency and currency equivalents may be dispensed by the remote account interface terminal and/or one or more other distributors.

At block 220, the currency, currency equivalent, or precious metal is dispensed. In one embodiment, precious metal distributor of terminal 102 dispensed precious metal in response to the precious metal dispersal instructions. The precious metal distributor may also be used to dispense currency and/or currency equivalents in response to the same or similar instructions. Alternatively, currency and currency equivalents may be dispensed by the remote account interface terminal and/or one or more other distributors in response to different instructions from the remote account interface.

FIG. 2B depicts a flow chart 230 of exemplary steps for depositing currency, a currency equivalent, and/or a precious metal, e.g., gold, at a terminal.

At block 232, a deposit request is received from a user. The deposit request may be received by a terminal 102. The deposit request may be a request to deposit one troy ounce of gold, for example.

At block 234, the deposit is accepted. The deposit may be accepted by a terminal 102. In one embodiment, for a precious metal deposit, the precious metal is inserted in the precious metal slot 8 of a terminal by a user. An optional verification step may then be performed on the precious metal as described in further detail below. In one embodiment, for a currency or check deposit, the currency or check is inserted in a deposit slot 6 of a terminal by a user. An optional verification step may then be performed on the currency or check as described in further detail below.

At block 236, a deposit fund request is sent to a remote server system. The terminal 102 may send the deposit fund request to the remote server system 104.

At block 238, the user's account is credited based on the deposit. The remote server system 104 may credit the user's account by increasing the value of the account corresponding to the accepted deposit. Crediting of the user's account may be subject to verification of the item deposited. For an account that has a currency based value, the account value may be increased by the currency equivalent of the deposited item. For an account that has a precious metal based value, the account value may be increased by the precious metal weight equivalent of the deposited item.

A few embodiments and specific examples are now described by way of non-limiting examples. Other embodiments/examples will be understood by one of skill in the art from the description herein and are considered within the spirit and scope of the present invention.

In one embodiment, user accounts are maintained by the private system 104a. In accordance with this embodiment, the private system 104a processes deposit and/or withdrawal requests received via the terminals 102b, authorizes the requests, generates account distribution information, and updates the user accounts. For withdrawal requests from a user at a terminal 102a, the private system 104a may verify that sufficient funds are accessible in the user's account, send account distribution information authorizing the withdrawal to the appropriate terminal 102a upon verification, and deduct the withdrawn amount from the user's account. For deposit requests from a user at a terminal 102a, the private system 104a may verify that the deposit has been made at the terminal 102a and add the deposited amount from the user's account (which may be subject to actual confirmation of what was deposited). This embodiment may be implemented using a closed, proprietary remote server system 104a with the user's account maintained by a private server system 104a.

In another embodiment, user accounts are maintained by one or more other entities 104b. In accordance with this embodiment, the other entity 104b processes deposit and/or withdrawal requests received via the terminals 102b, authorizes the requests, generates account distribution information, and updates the user accounts. For withdrawal requests from a user at a terminal 102a, the other system 104b may verify that sufficient funds are accessible in the user's account, send account distribution information authorizing the withdrawal to the appropriate terminal 102a upon verification, and deduct the withdrawn amount from the user's account. For deposit requests from a user at a terminal 102a, the other system 104b may verify that the deposit has been made at the terminal 102a and add the deposited amount from the user's account (which may be subject to actual confirmation of what was deposited). This embodiment may be implemented using conventional currency based entities 104b such as banks and credit card companies. In accordance with such an implementation, a user's account may be maintained at the financial institution of their choice. The user may then access their credit line, for example, to make precious metal withdrawal at a terminal.

In other embodiments, user accounts are maintained by the private entity 104a and/or one or more other entities 104b. In accordance with these embodiments, the private entity 104a processes deposit and/or withdrawal requests received via the terminals 102b, authorizes the requests based on communications with the other entities, generates account distribution information, and optionally updates the user accounts (which may be maintained the other entities 104b). For withdrawal requests from a user at a terminal 102a, the private entity 104a may receive the request and communicate with the other entities 104b to verify that sufficient funds are accessible in the user's account maintained with the other entities, send account distribution information authorizing the withdrawal to the appropriate terminal 102a upon verification, and optionally deduct the withdrawn amount from the user's account if maintained by the private entity. The other entities 104b may deduct the amount from user accounts maintained by these entities. For deposit requests from a user at a terminal 102a, the private entity 104a may verify that the deposit has been made at the terminal 102a, communicated the deposit to the other entities 104b and optionally add the deposited amount to the user's account if maintained by the private entity (which may be subject to actual confirmation of what was deposited). The other entities 104b may add the amount from user accounts maintained by these entities. These embodiment may be implemented using private entities 104a and conventional currency based entities 104b such as banks and credit card companies. In accordance with such an implementation, a user's account may be maintained at the financial institution of their choice. The user may then access their credit line, for example, to make a precious metal withdrawal at a terminal through the private entity 104a. For example, the user may make a withdrawal request at a terminal to withdraw gold using funds maintained at the user's bank. The withdrawal request may be sent to the private entity 104a. The private entity 104a may then communicate with the other entities 104b to verify and receive the funds. Once the funds are received by the private entity 104a, the private entity may send account distribution information to the terminals.

In one embodiment, the system 100 is able to recognize gold bars and/or other precious metal items (e.g., via unique serial numbers). In accordance with this embodiment, the user may deposit the recognizable precious metal using the terminals 102 described herein for credit to the customer account. The user may first selects which type of precious metal they want to deposit: either a recognized bar (one that has been previously issued by the private company and whose serial number is on file in the company database) or an unrecognized bar or coin (which is subject to assay and certification). The user may inserts the item in a clear sealed plastic transparent case secured from the supplies door (numbered with receipt for customer) and inserts it into the slot 8 where a clear high impact glass door may slide into place. A high resolution scan may be made to confirm the identity of the item as entered on the screen by the user. If the user and machine description vary then the user may elect to cancel the transaction and the door then opens and he can withdraw the item and cancel the transaction. If the user agrees with the description he proceeds with the transaction and the item is credited to his physical account holdings subject to verification of the item's authenticity. The item is then dropped down a chute from the inspection slot and sealed into a box which is deposited into a metal tube with other boxes. The deposited precious metal is stored inside the machine and a deposit receipt is printed. Once collected, the tube is secured from tampering and can only be opened in a filmed central metals assessment and collection center, for example. Once all the requirements are met and authenticity has been established the amount will be credited to the customer's account.

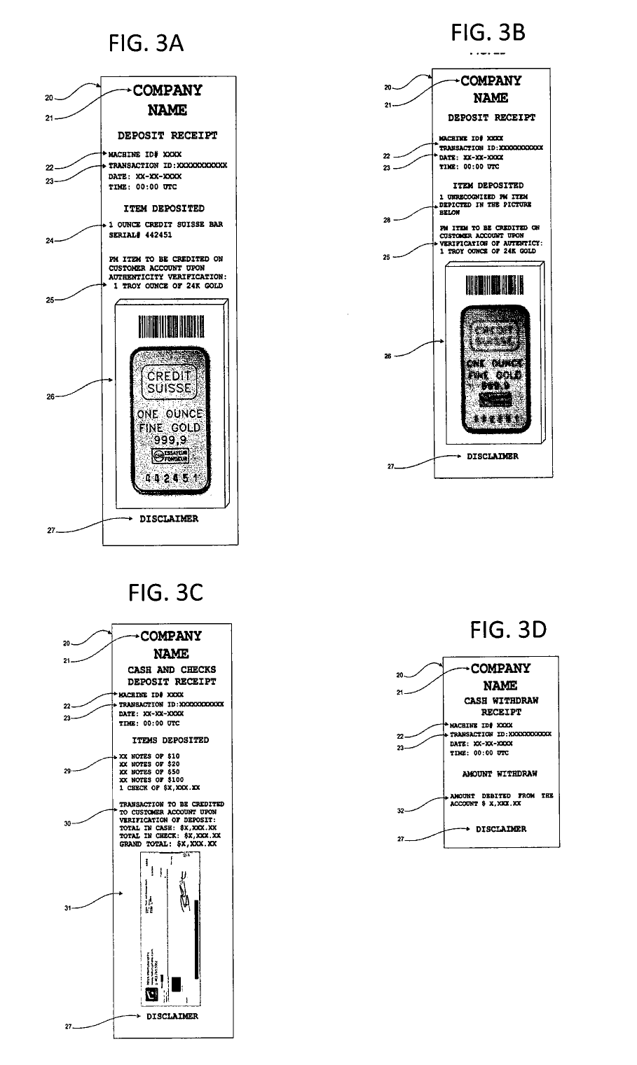

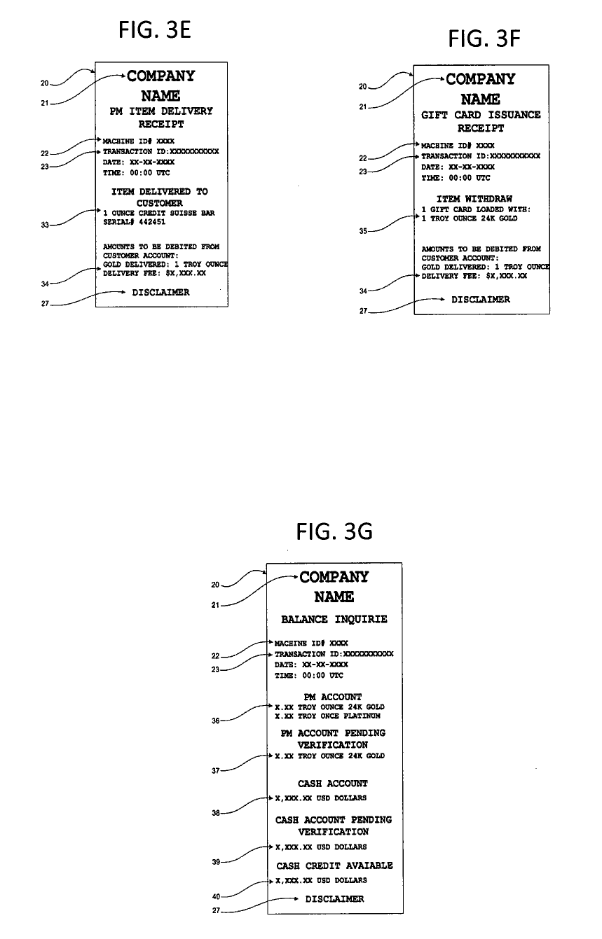

FIG. 3A depicts a receipt 20 where the precious metal is recognized. The receipt include the private company name 21, terminal identification 22, transaction identification 23, deposited precious metal description 24, precious metal to be credited 25, photo of deposited item 26, and a disclaimer 27. FIG. 3B depicts a receipt 20 where the precious metal is not recognized.

In one embodiment, the system 100 enables the deposit of cash and/or checks for credit to a user's account. This transaction may take place similar to a conventional ATM and a receipt 20 such as depicted in FIG. 3C is printed. The receipt 20 depicted in FIG. 3C includes deposited cash/check description 29, cash/check amount to be credited 30, and photo of deposited check 31.

In one embodiment, the system 100 enables withdrawal of cash from a user's account. This transaction may take place similar to a conventional ATM and a receipt such as depicted in FIG. 3D is printed. The receipt 20 depicted in FIG. 3D includes the amount 32 debited from the user's account.

In one embodiment, the system 100 enables withdrawal of precious metal by a user. After a user accesses their account as described above he can elect to withdraw precious metal, e.g., up to 3 gold bars per 24 hour period, from his account (provided he has the appropriate level of equity in his account). A conversion fee for taking physical delivery may apply to the transaction. This transaction may take place in a manner similar to the withdrawal of funds from a conventional ATM as described above. The precious metal may be dispensed into a delivery bin 9 and a receipt 20 such as depicted in FIG. 3E may be printed. The receipt 20 depicted in FIG. 3E include a description of the item delivered 33 and the delivery fee 34.

In one embodiment, the system 100 enables issuance of debit/gift card to pay others. After the user accesses his account as described above he can elect to issue gift cards (e.g., up to 3 card and a total of 3 ounces per 24 hour period) for gold bars from his account (provided he has the appropriate level of equity in his account). In an exemplary embodiment, each card is limited to one bar and there is a conversion fee for taking physical delivery of the precious metal. This transaction may be performed similar to withdrawal of funds from a conventional ATM as described above. The cards may be dispensed into the card delivery tray 10 and a receipt 20 such as depicted in FIG. 3F may be printed. The receipt 20 depicted in FIG. 3F a description 35 of the cards “value.” In an alternative embodiment, an electronic “code” associated with an item may be communicated to a wireless device such as a cell phone where the code may be presented at another terminal to receive the item.

In one embodiment, the system 100 enables account transactions that do not require a dispensed item or cash (e.g., hedging, sales, purchase, balance inquiry, etc.). Transactions such as account balance inquiries, precious metals values, hedging or insurance transactions, sales or purchases can be accomplished through either the Internet or at the terminal/ATM location. In the event of a purchase, sale or other market influenced transaction, the terminal through a constant data connection with the remote server may receive the actual value of the precious metal or contract based on current market values. If market is closed, an estimated value may be used based on closing price quotation with the item valued upon market opening. Receipts 20 such as depicted in FIG. 3G may be issued. The receipt 20 depicted in FIG. 3G includes a precious metal holding description 36, a precious medal pending transaction description 37, a currency value 38, a currency pending transaction description 38, and a credit available description 40.

An aspect of some receipts 20 is the description of items deposited 24 and a unique serial number 24 recognized through a digital photo 26. The digital copy of the image of the actual precious metal item in case of error in the serial number recognition algorithm or in the event of an unrecognized item 22 provides a means for verifying transactions. Additionally, the univocal number of the transaction 23 and, optionally, the univocal number of the machine 22 enables retrieval of all details of the transaction including account number of the customer, time, date, interval snapshot of the machine camera during the transaction, etc.

In one exemplary use, an initial account may be set up online with or at a physical location of an entity that facilitates transactions in accordance with one or more aspects of the present invention, or through a financial institution that is an agent or is otherwise affiliated with such an entity. Once the account is set up the user may deposit funds such as US currency through a terminal/ATM or via wire transfer and precious metals either through the terminal/ATM or shipped to the entity's offices. He can manage his holdings (buy, sell, transfer from one precious metal to another, hedge, speculate, etc.) both online and at the ATM. He would have access to dollar credit against the account holdings on deposit via an account backed debit card, with the option to pay the card balance off at the end of the billing cycle or have some of his funds liquidated to cover purchases. He would also have the ability to receive and deposit precious metals/cash at the ATM himself, as well as be able to issue secure transfer cards whereby people he wishes to pay may obtain gold from the ATM, which will be debited from his account. Metals that are deposited at the ATM would be credited subject to initial and final verification; user would have the option of trading against any deposit subject to having equity in his account to cover market risk or losses in the case of a “bad deposit” (like a bad check). The user's identity may be established with some sort of combination of facial recognition software, fingerprints, or iris-scan and sophisticated chip mechanisms in their card.

In one embodiment, the terminal/ATM is able to “recycle” cash. In accordance with this embodiment, currency deposited in the terminal/ATM may be held by the terminal for later distribution. For example, if a first user deposits $1,000 in a terminal to withdraw a quantity of gold, the $1,000 may be processed by the terminal/ATM for delivery to a second user that is making a currency withdrawal.

An exemplary practical and legal difference of aspects of the present invention is that the user is actually opening an account and acquiring and/or selling precious metals. They may take physical delivery if they so elect for themselves and may conduct transfers to others whether or not they are account holders. They would also have access to “insurance” (special contracts that would allow him to protect against losses in the metals value), as well as have the ability to conduct leveraged trades on margin. Additionally, accessing the user account from the terminal/ATM allows them to make instantaneous deposits/withdraws of cash and/or metals and receive immediate credit for (subject to verification of authenticity) or obtain immediate physical possession of the items or cash without the use of mails or middlemen.

Although the invention is illustrated and described herein with reference to specific embodiments, the invention is not intended to be limited to the details shown. Rather, various modifications may be made in the details within the scope and range of equivalents of the claims and without departing from the invention.

1. An unattended precious metal distribution apparatus, the apparatus comprising:
a precious metal distributor, the precious metal distributor configured to dispense precious metal to a user in response to dispersal instructions; and
a remote account interface coupled to the precious metal distributor that is accessible by the user, the remote account interface configured to receive withdrawal fund information for an account maintained on a remote server system and to issue the dispersal instructions based on the withdrawal fund information.

2. The apparatus of claim 1, wherein the remote account interface is an automated teller machine (ATM).

3.-6. (canceled)

7. The apparatus of claim 1, further comprising:
a dispenser coupled to the remote account interface, wherein the remote account interface is further configured to dispense a currency equivalent to the user via the dispenser based on equity in the account.

8. (canceled)

9. The apparatus of claim 1, wherein the precious metal distributor is further configured to accept precious metal and wherein the remote account interface is further configured to send deposit fund information to the remote account based on the accepted precious metal.

10. (canceled)

11. The apparatus of claim 1, further comprising:
a card dispenser coupled to the remote account interface, the card dispenser configured to dispense a precious metal card to the user in response to card issue instructions, wherein the remote account interface is further configured to issue the card issue instructions based on the withdrawal fund information.

12.-13. (canceled)

14. An unattended precious metal distribution system, the system comprising:
a plurality of unattended precious metal distribution terminals, the plurality of terminals configured to dispense precious metal in response to account distribution information; and
a remote server system accessible by the plurality of unattended precious metal distribution terminals, the remote server system configured to generate the account distribution information based on user accounts maintained by the remote server.

15. The system of claim 14, wherein one or more of the plurality of unattended precious metal distribution terminals include an automated teller machine (ATM).

16. The system of claim 14, wherein the remote server system maintains a value for the account that is currency based.

17. The system of claim 14, wherein the remote server system maintains a value for the account that is precious metal based.

18. The apparatus of claim 14, wherein the remote server system maintains a first value for the account that is currency based and maintains a second value for the account that is precious metal based.

19. The apparatus of claim 17, wherein the plurality of terminals are further configured to dispense currency to the users based on equity in the account.

20. The apparatus of claim 17, wherein the plurality of terminals are further configured to dispense a currency equivalent to the users based on equity in the account.

21. (canceled)

22. The apparatus of claim 14, wherein at least one of the plurality of terminals is further configured to accept precious metal and to send deposit fund information to the remote account based on the accepted precious metal.

23.-24. (canceled)

25. An unattended precious metal distribution method, the method comprising the steps of:
maintaining a plurality of user accounts on a server system; and
permitting access to the plurality of user accounts from a plurality of unattended precious metal distribution terminals.

26. The method of claim 25, wherein the permitting access step comprises:
dispensing precious metal from one or more of the plurality of unattended precious metal distribution terminals; and
wherein the maintaining step comprises:
decreasing the value of one or more user accounts corresponding to the dispensed precious metal.

27. (canceled)

28. The method of claim 25, wherein the permitting access step comprises:
accepting precious metal at one or more of the plurality of unattended precious metal distribution terminals; and
wherein the maintaining step comprises:
increasing the value of one or more user accounts corresponding to the accepted precious metal.

29.-31. (canceled)

32. The method of claim 25, wherein the maintaining step comprises:
maintaining a value for each of the accounts that is precious metal based.

33. The apparatus of claim 25, wherein the maintaining step comprises:
maintaining a first value for each of the account that is currency based; and
maintaining a second value for each of the account that is precious metal based.

34. The method of claim 32, wherein the permitting access step comprises:
dispensing at least one of currency or a currency equivalent from one or more of the plurality of unattended precious metal distribution terminals.

35.-36. (canceled)

37. The method of claim 25, wherein the permitting access step comprises:
dispensing a card from one of the plurality of unattended precious metal distribution terminals, the card permitting withdrawal of precious metal from another of the plurality of unattended precious metal distribution terminals.
